(19) United States
(12) Patent Application Publication
(10) Pub. No.: US 2026/0331623 A1
(43) Pub. Date: Oct. 22, 2026

(54) THERMALLY CONDUCTIVE POLYMER COOLING PLATE FOR BATTERY THERMAL MANAGEMENT

(71) Applicant: TI Group Automotive Systems, LLC, Auburn Hills, MI (US)

(72) Inventors: Kit JONES, Coventry (GB); Andrew SUTHERLAND, Auburn Hills, MI (US); Jon HOLTZ, Auburn Hills, MI (US); Albert BOECKER, Rastatt (DE); Matthias WINTER, Rastatt (DE)

(21) Appl. No.: 19/115,021

(22) PCT Filed: Sep. 26, 2022
(86) PCT No.: PCT/US2022/044673

§ 371 Date: Mar. 25, 2025

(51) Int. Cl. H01M 10/653; B60L 50/64; H01M 10/613; H01M 10/6568

(52) U.S. Cl. CPC H01M 10/653; B60L 50/64; H01M 10/613; H01M 10/6568; H01M 2220/20

(57) ABSTRACT

A cooling plate for battery thermal management in a battery pack and a process of forming such battery pack is provided. The cooling plate is formed of a composite material in the shape of a hollow structure. This composite material has a composition that includes a thermally conductive filler dispersed within a polymeric matrix. The hollow structure has an external wall with a thickness that is in the range of about 0.3 millimeters (mm) to about 2.5 mm. The hollow structure includes a top section, the top section being in thermal contact with at least one battery; a bottom section; the bottom section being integrally formed with the top section; and one or more channels located between the top section and the bottom section, the one or more channels being configured to allow a fluid to flow there through in order to provide for thermal management of the battery.

### RELATED APPLICATIONS

The present disclosure claims priority to and is a national phase application of PCT Application PCT/US 2022/044673, filed Sep. 26, 2022, the entire contents of which are incorporated herein by reference.

### FIELD

The invention relates to a cooling plate for use in providing thermal management for a battery or battery module and/or a battery pack.

### BACKGROUND

The statements in this section merely provide background information related to the present disclosure and several definitions for terms used in the present disclosure and may not constitute prior art.

Currently, it is common in an electric vehicle (EV) or a hybrid electric vehicle (HEV) to provide heat transfer to/from the battery pack using an aluminum plate. This cooling plate is typically located at the bottom of the battery pack, which typically houses a plurality of batteries or battery modules. The cooling plate allows for the circulation of fluid there through for the purpose of heat transfer. Examples of the type of fluid generally used includes water or a water/glycol mixture. As the aluminum plate is electrically conductive, some form of polymeric pad or adhesive layer is generally located between the batteries in the battery pack and the cooling plate. Thus, this pad is in physical contact with both the battery and the cooling plate. The use of this pad also assists in eliminating any air gaps, which exist due to assembly tolerances and the roughness of the external surfaces for the batteries and the cooling plate. This pad or adhesive layer in combination with the aluminum plate may negatively impact the cost, assembly, recycling, and weight of the battery pack/cooling plate combination.

Another type of cooling plate can be formed using a film or composite foil as a flexible top layer in conjunction with a stiff lower plate. This film or composite foil has a very thin cross-section, which is on the order of 100 micrometers or less. The composite foil is inflated similar to a balloon by a fluid that is circulated there through. All contact forces exerted against the battery are achieved via this inflation technique. However, the performance and longevity of this type of cooling plate remains to be determined since the thin cross-section of the inflatable film is limited in its thermal conductivity and subject to tear. In addition, the thin film or composite foil may not be able to withstand the weight or dynamic forces exerted by the batteries that the film or foil attempts to support.

### SUMMARY

An objective of the present disclosure is to overcome the aforementioned disadvantages and to provide an improved cooling plate for use in the thermal management of a battery or battery pack. In this respect, the present disclosure generally comprises a cooling plate for battery thermal management. This the cooling plate comprises a composite material formed in the shape of a hollow structure having an external wall with a thickness that is in the range of about 0.3 millimeters (mm) to about 2.5 mm. The composite material has a composition that includes a thermally conductive filler dispersed within a polymeric matrix. When desirable, the thermally conductive filler may also exhibit a low level of electrical conductivity. This hollow structure comprises: a top section that is in thermal contact with at least one battery; a bottom section that is integrally formed with the top section; and one or more channels located between the top section and the bottom section. The one or more channels are configured to allow a fluid to flow there through in order to provide for thermal management of the battery. The incorporation of the composite material into the hollow structure the results in less than about 15% volume change upon allowing the fluid to flow through the one or more channels. When desirable, the hollow structure may be formed as a single component.

The thermally conductive filler comprises a plurality of particles having a composition selected from the group consisting of boron nitride, alumina, aluminum nitride, silicon nitride, silicon carbide, graphene, carbon nanotubes, or a mixture thereof. The polymeric matrix is an elastomer, a thermoplastic, or a thermoplastic elastomer (TPE) having a Shore A hardness that is in the range of about 40 to 100 or a Shore D hardness that is in the range of 20 to about 75. Alternatively, the composition of the composite material comprises a plurality of boron nitride particles dispersed in a thermoplastic elastomer (TPE) having a Shore A hardness in the range of about 70 to about 80. The thermally conductive filler comprises between about 5 wt. % to about 25 wt. % of the overall weight of the composite material.

According to one aspect of the present disclosure, the one or more channels in the hollow structure may include a structural element configured to support the weight of the battery. This structural element may have a composition that is different from the composition of the cooling plate. In addition, when desirable, at least one of the bottom section and top section may include one or more features configured to increase stiffness and to promote fluid mixing by directing the flow of the fluid. These features may protrude into the one or more channels from the top section, the bottom section, or both the top section and bottom section.

The top section of the cooling plate may be flat in order to maintain at least 50% surface contact with the battery. The top section may further include one or more bump stops configured to assist in battery placement and retention.

According to another aspect of the present disclosure, a battery pack with thermal management is provided. This battery pack comprises: at least one battery; and a cooling plate comprising a composite material formed in the shape of a hollow structure as previously described above and further defined herein.

According to another aspect of the present disclosure, the cooling plate may be used to provide for thermal management of at least one battery in an electric vehicle (EV) or hybrid electric vehicle (HEV).

According to yet another aspect of the present disclosure, a process of forming a battery pack configured for thermal management is provided. This process comprises: providing a composite material; subjecting the composite material to a molding process in order to form a hollow structure; providing at least one battery; assembling the at least one battery with the hollow structure, such that the battery is in thermal contact with a top section of the hollow structure; and allowing a fluid to flow through one or more channels located within the hollow structure. When a molding process is utilized this process may be selected as one from the group consisting of blow molding, injection molding, compression molding, rotational molding; or a combination thereof When desirable this process may further comprise forming one or more structural elements present in at least one channel of the hollow structure in order to assist in supporting the weight of the batteries or battery modules. These structural elements may be formed by a molding process, such as for example, blow molding utilizing “Ship-in-the-Bottle” technology.

When desirable the process may further comprise forming one or more features that protrude into the one or more channels from the top section, the bottom section, or both the top and bottom sections in order to increase stiffness and to promote fluid mixing by directing the flow of the fluid.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1 is a schematic representation showing a peripheral view of a battery pack containing a cooling plate formed according to the teachings of the present disclosure.

FIG. 2A is a cross-sectional view of the battery pack of FIG. 1 taken along axis x in which the hollow structure of the cooling plate 15 is depicted in more detail.

FIG. 2B is a cross-sectional view of another battery pack similar to that shown in FIG. 2A, wherein an alternative structure for the cooling plate is depicted.

FIG. 3 is a cross-sectional view of the battery pack of FIG. 2B wherein a structural element is formed within the channel(s) according to the teachings of the present disclosure.

FIG. 4 is a perspective exploded view of the battery pack of FIG. 1 showing the inclusion of features that protrude into the channel(s) of the cooling plate according to the teachings of the present disclosure.

FIG. 5 is a perspective view of the bottom section of the cooling plate of FIG. 4 highlighting the flow of fluid through the protruded features in the channel(s).

FIG. 6 is a schematic showing the use of a composite material to form the top section, bottom section, and sides connecting the top and bottom sections according to the teachings of the present disclosure.

FIG. 7 is a flowchart of a process used to form a battery pack according to the teachings of the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. For example, the cooling plate made and used according to the teachings contained herein is described throughout the present disclosure in conjunction with the thermal management of a battery or battery pack in an electric vehicle (EV) or a hybrid electric vehicle (HEV) in order to more fully illustrate the structural elements and the use thereof. The incorporation and use of such a cooling plate in other applications, including without limitation, in other electric equipment or devices that utilize a battery or battery pack is contemplated to be within the scope of the present disclosure. It should be understood that throughout the description and drawings, corresponding reference numerals indicate like or corresponding parts and features.

As used herein a “battery cell” refers to the basic electrochemical unit of a battery that contains an anode and a cathode, as well as any components used to convert stored chemical energy to electricity, such as, for example, electrodes, a separator, and an electrolyte. In comparison, a “battery” or “battery module” refers to at least one battery cell placed within a housing with electrical connections and possibly electronics for control and protection. A “battery pack” refers to a collection of more than one battery, in other words a plurality of battery modules, connected either in series or parallel to one another in order to increase the voltage or capacity arising therefrom with the collection of batteries being secured within a housing.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

The present disclosure provides a cooling plate for battery thermal management. This cooling plate generally comprises a composite material having a composition that includes a thermally conductive filler dispersed within a polymeric matrix that is formed in the shape of a hollow structure. This hollow structure comprises a top section, a bottom section and one or more channels located between the top and bottom sections. At least one of the top section or bottom section of the hollow structure is in thermal contact with at least one battery. In other words, the cooling plate is in thermal contact with a portion of the battery, for example, with a top, bottom, or side portion of the battery module. The bottom section is integrally formed with the top section. The one or more channels are configured to allow a fluid to flow there through in order to provide for the thermal management of the battery.

The cooling plate formed according to the present disclosure comprising a composite material provides for good thermal conductivity between the battery or battery pack and the heat transfer fluid that circulates through the cooling plate. The use of a polymeric matrix with a thermally conductive filler dispersed therein to form the cooling plate, provides a relatively soft and flexible composite material that allows for efficient heat transfer and eliminates the need for the use of a polymeric pad or an adhesive layer. In this respect the thermally conductive filler enables good thermal conductivity, while the polymeric matrix is sufficiently soft and flexible to directly eliminate gaps and provide for good physical contact between the cooling plate and the battery or battery pack. In addition, upon allowing the fluid to flow through the one or more channels in the cooling plate, the composite material used to form the hollow structure may change its volume by 20% or less; alternatively, less than 15%; alternatively, about 10% or less; alternatively, no greater than 5%. Since the thermally conductive filler may also exhibit low electrical conductivity, the use of the composite material may also effectively provide for electrical insulation of the battery pack.

Although the cooling plate of the present disclosure is not as thermally conductive as a conventional, commercially available, aluminum cooling plate, the thermal conductivity provided by the composite material is capable of providing the performance necessary or desired for the thermal management of a battery pack. In addition, a cooling plate formed according to the teachings of the present disclosure that comprises a composite material provides the additional advantages over conventional cooling plates of being less expensive to manufacture, lighter in weight, easier to assemble, a reduced chance for the occurrence of a short circuit within the battery pack, and in some cases, even easier to recycle (e.g., versus adhesive-based options). The process of forming the cooling plate opens up the commercial feasibility of producing a product for small volume markets due to the need for lower investment costs, which are driven by the differences that exist in tooling in comparison to the manufacturing processes associated with conventional cooling plates.

For the purpose of this disclosure, the terms “about” and “substantially” as used herein with respect to measurable values and ranges refer to the expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one channel”, “one or more channels”, and “channel(s)” may be used interchangeably and are intended to have the same meaning.

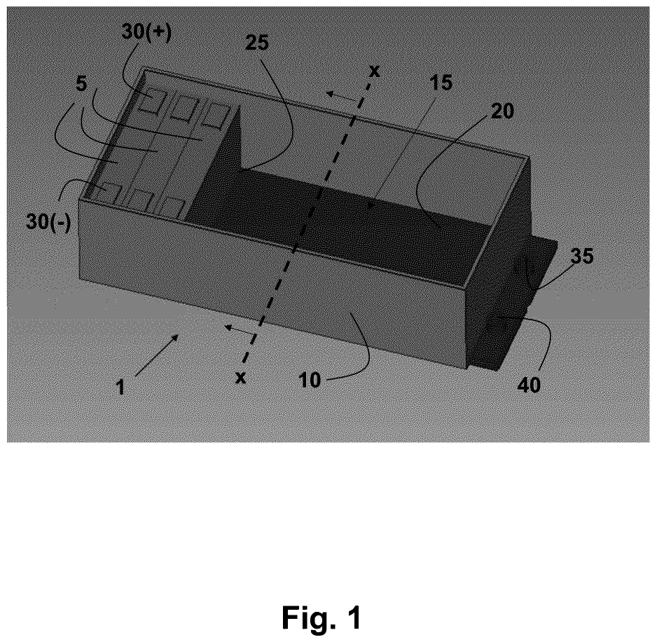

Referring now to FIG. 1, a battery pack 1 is shown with three batteries 5, each having a positive 30(+) and negative 30(−) terminal positioned in a housing 10 associated with the battery pack 1. A cooling plate 15 is located such that the top section 20 of the cooling plate 15 is in thermal contact with at least one battery 5, alternatively, with all of the batteries 5 with in the battery pack 1. As shown in FIG. 1, in order to more fully illustrate the structure of the cooling plate 15 and the use thereof, the cooling plate 15 is depicted in each of the figures herein as contacting the bottom of the batteries or battery modules. However, the cooling plate may be turned upside down, such that the top section 20 of the cooling plate is in contact with the top surface of the batteries 5 or battery modules 5 without exceeding the scope of the scope of the present disclosure. In a similar fashion, when necessitated by or desired for a particular application the cooling plate 15 may be configured such that the top section 20 of the cooling plate is in thermal contact with one or more sides of the batteries or battery modules within the battery pack.

The surface of the top section 20 of the cooling plate 15 is generally flat in order to enhance thermal contact and/or thermal communication with the batteries 5. The top section 20 of the cooling plate 15 may also include one or more bump stops 25 or bosses that are configured to assist in battery 5 placement and retention within the battery pack 1.

Still referring to FIG. 1, the use of a composite material to form the cooling plate provides sufficient ability for the top section 20 of the cooling plate 15 to conform to and establish contact with the batteries 5, overcoming any surface roughness or unevenness that may inherently exist. The top section 20 of the cooling plate 15 is able to maintain at least 50% surface contact with the batteries 5. Alternatively, the cooling plate 15 maintains between 50% and 100% surface contact with the batteries 5; alternatively, greater than 50% and less than 100%; alternatively, between 55% and 95%; alternatively, about 60% to about 90%. For the purpose of the present disclosure, the term “between” is intended to include the limits specified for the stated range.

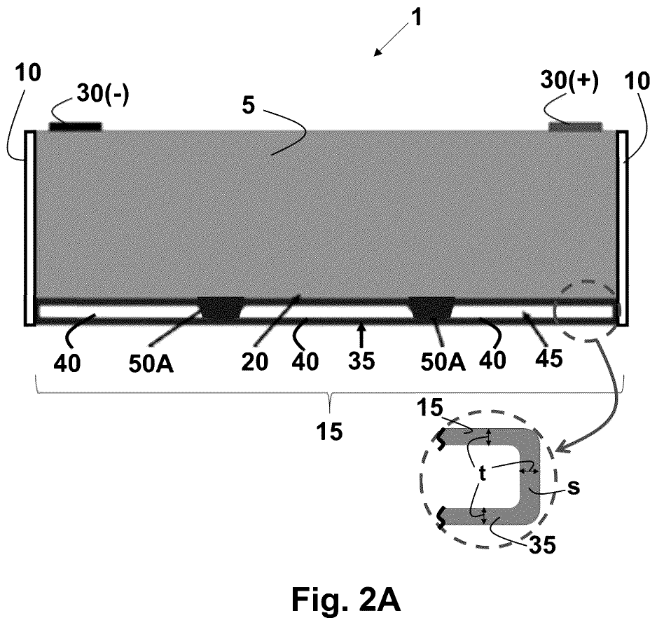

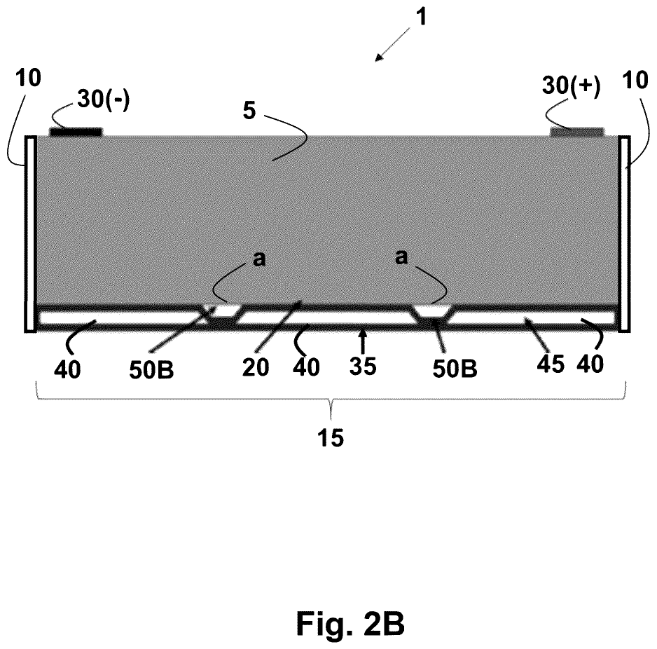

Referring now to FIG. 2A, a cross-sectional view of the battery pack 1 of FIG. 1 taken along axis x is shown in which the hollow structure of the cooling plate 15 is depicted in more detail. More specifically, in addition to the top section 20 being in thermal contact with the batteries 5, a bottom section 35 is integrally formed with the top section 20, and one or more channels 40 are depicted through which a fluid 45 flows to provide for the thermal management of the batteries 5. The cooling plate 15 is shown in FIG. 2A with three channels 40 formed therein separated by solid structures 50A formed there between that separate the channels 40 and provide structural support for the cooling plate 15 in order to be able to support the overall mass of the batteries 5.

For the purpose of this disclosure, the term “integrally formed” is meant to imply that the top section 20 and the bottom section 35 are formed or molded as a single component and/or that the top section 20 and the bottom section 35 are joined together to form a “leak-free” hollow structure through the use of one more of ultrasonic welding, spin welding, vibration welding, hot plate welding, infrared welding, laser welding, and overmolding processes. Alternatively, the cooling plate 15 is formed as a single component. Any process known to one skilled in the art that can form a single component from a composite material may be utilized, such as for example, without limitation, injection molding or blow molding.

The hollow structure of the cooling plate 15 is formed with an external wall thickness (t) that is in the range of about 0.3 millimeters (mm) to about 2.5 mm. Alternatively, the wall thickness (t) may in the range of about 0.5 mm to about 2.3 mm; alternatively, about 1.0 mm to about 2.0 mm. The wall thickness (t) of the top section 15, the bottom section 35, and the sides(s) that join the top section 15 and bottom section 35 may be the same or different depending upon the structural design and manufacturing parameters utilized for the given application. For example, the selection of the wall thickness (t) may vary depending upon the thickness necessary to provide adequate stiffness to support the weight of the batteries and to maintain a stress level in the structure of the cooling plate that is below the yield stress of the composite material used to form the structure.

Referring now to FIG. 2B, a cross-sectional view of a battery pack 1 similar to that shown in FIG. 2A is provided in which the solid structural supports 50A (see FIG. 1) are replaced with angled structural supports 50B. Such an angled structural support 50B design may be desirable depending upon the type of process (e.g., for example, blow molding, etc.) selected for use in forming the cooling plate 15. The use of an angled structural support 50B design creates a small area (a) in which there will be very limited or no heat transfer occurring due to the lack of thermal contact between the top section 20 of the cooling plate 15 and the batteries 5. The existence of this small area (a) will not affect the performance of the cooling plate 15 in providing for the thermal management of the batteries 5 when the overall contact between the top section 20 of the cooling plate 15 and the batteries 5 is maintained at 50% or more surface contact as previously discussed herein.

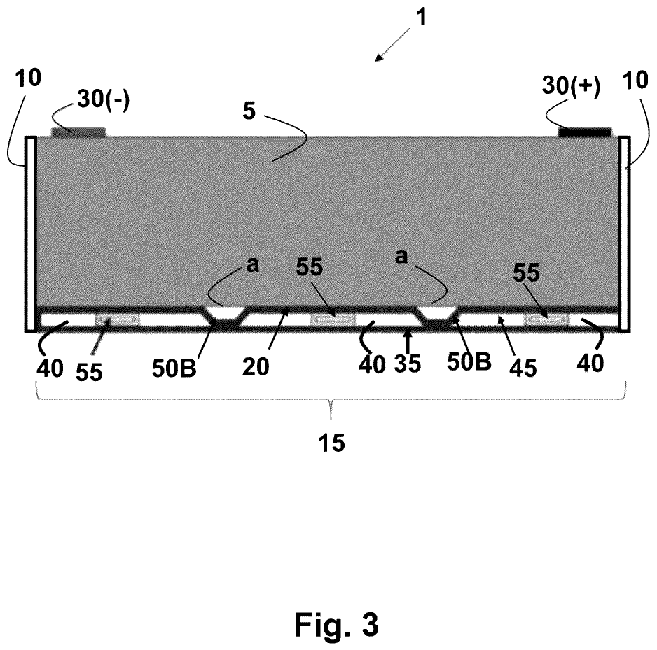

Referring now to FIG. 3, a cross-sectional view of the battery pack 1 having the cooling plate of FIG. 2 incorporated therein is shown with the inclusion of a structural element 55 in one or more of the channels 40 present in the cooling plate 15. The structural element(s) 55 are configured to assist the cooling plate 15 in supporting the weight of the batteries 5. The structural element(s) may be made of the same material as the cooling plate 15, made of a different material, or made of a combination thereof. Alternatively, the structural element(s) are made of high density polyethylene (HDPE). These structural element(s) may be made as separate components and integrated with the cooling plate during the formation of the hollow structure in any process configured for such purpose, including, but not limited to the use of “Ship-in-the-Bottle” technology in a blow molding process.

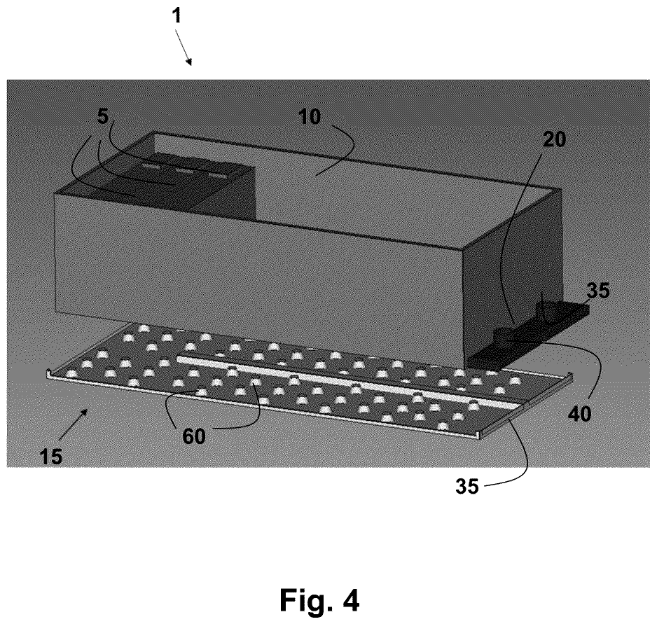

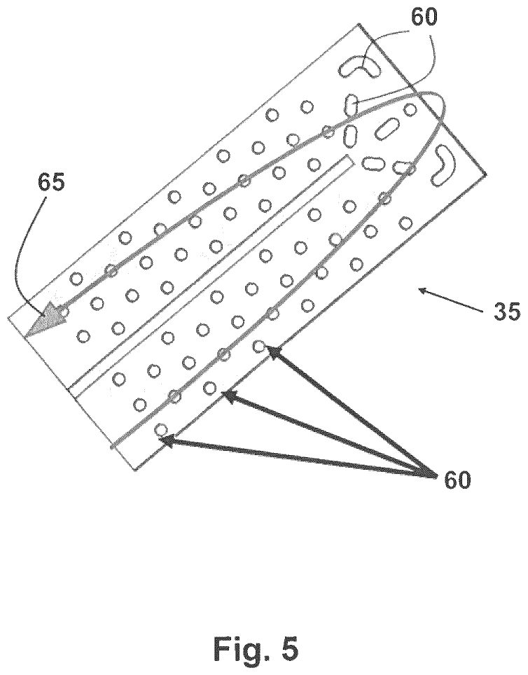

Referring now to FIG. 4, a perspective view of battery pack 1 according to another aspect of the present disclosure is provided. This perspective view highlights that the bottom section 35 may be contoured to control flow and provide for additional stiffness. In this respect, the bottom section 35 may include one or more features 60 configured to increase stiffness and to promote fluid mixing by directing the flow of the fluid. These feature(s) 60 protrude into the one or more channels from the bottom section 15 (as shown in FIG. 4), from the top section, or from both the top section and bottom section. The shape of the features 60 may be any shape including, without limitation, cylindrical, oblong, or angled. The number of features 60, the shape of the features 60, and the positioning of the features 60 are selected so that they provide the desired flow and/or mixing of the fluid in the channel(s). In FIG. 5, the flow path 65, which providing mixing of the fluid in the presence of the features 60 protruding into the one or more channels of the cooling plate of FIG. 4, is schematically shown with respect to features 60 arising from the bottom section 35 of the cooling plate 15. The fluid may comprise any type of heat transfer liquid, including without limitation, water or a water/glycol mixture.

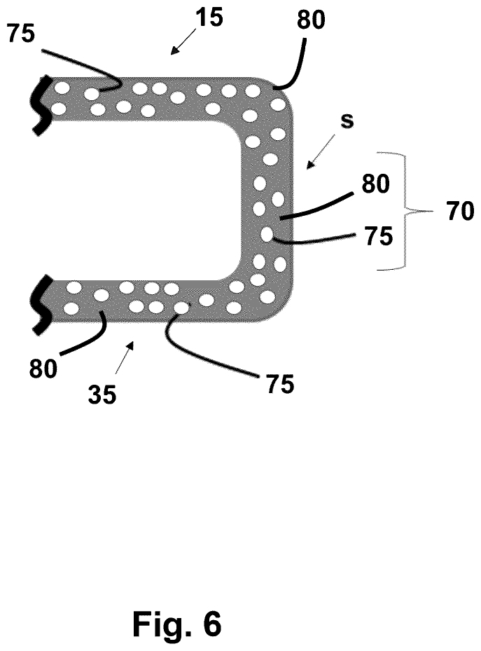

Referring now to FIG. 6, the top section 15, the bottom section 35 and the sides (s) that join the bottom and top sections of the cooling plate generally comprise a composite material 70. This composite material 70 consists of, consists essentially of, or comprises a thermally conductive filler 75 dispersed in a polymeric matrix 80. This thermally conductive filler 75 may also exhibit a low level of electrical conductivity in order to assist in the electrical isolation of the batteries. For the purpose of this disclosure, a low level of electrical conductivity exhibited by the thermally conductive filler is defined as being on the order of 9.9×10⁵ S/m or less; alternatively, on the order of 9.9×10⁴ S/m or less. Alternatively, the electrical conductivity of the thermally conductive filler is low enough that the filler is classified as an electrical insulator.

The thermally conductive filler 75 comprises a plurality of particles having a composition comprising boron nitride, alumina, aluminum nitride, silicon nitride, silicon carbide, graphene, graphite, carbon nanotubes (single-walled or multi-walled), or a mixture thereof. The particles may have any feasible shape including without limitation, spherical, flat (e.g., platelets), irregular, or oblong (e.g., fibers). The particles may also be described as being in any feasible crystalline form that provides for thermal conductivity. Alternatively, boron nitride when used as the conductive filler provides a level of thermal conductivity and electric insulation desirable for use in many applications. Boron nitride (BN) particles when used as the thermally conductive filler may comprise either a hexagonal crystallographic form (H-BN) or a cubic crystallographic form (C-BN); alternatively, the thermally conductive filler is H-BN.

Still referring to FIG. 6, the polymeric matrix 80 comprises an elastomer, a thermoplastic, or a thermoplastic elastomer (TPE) having a Shore A hardness that is in the range of about 40 to 100 or a Shore D hardness that is in the range of 20 to about 75. Alternatively, the polymeric matrix is a thermoplastic elastomer (TPE) having a Shore A hardness in the range of about 50 to about 90 or a Shore D hardness of about 45 to about 75; alternatively, a Shore A hardness in the range from about 70 to about 80. The Shore A hardness and/or the Shore D hardness may be measured using a Shore® (Durometer) test according to ASTM D22440 00, ISO 7619 and ISO 868; DIN 53505; and/or JIS K 6301, which has been superseded by JIS K 6253. Alternatively, the polymeric matrix is a thermoplastic having a Shore D hardness in the range of about 60 to 75.

The TPE used as the polymeric matrix 80 may comprise, without limitation styrenic block copolymers (TPE-S), polyolefin blends (TPE-O), thermoplastic polyurethanes (TPE-U), thermoplastic copolyesters (TPE-E), thermoplastic polyamides (TPE-A), or a mixture thereof. Alternatively, the thermoplastic used as the polymeric matrix 80 is high density polyethylene (HDPE). The polymeric matrix is selected based on a combination of properties, including but not limited to hardness, cost, environmental impact, and the processing method available to form the hollow structure of the cooling plate. The type of polymeric matrix selected for a given application may affect the wall thickness (t) of the cooling plate in order to achieve the necessary compliance to provide the required or desired contact with the batteries. According to one aspect of the present disclosure, the composition of the composite material 70 comprises a plurality of boron nitride particles dispersed in a thermoplastic elastomer (TPE) having a Shore A hardness in the range of about 70 to about 80.

The thermally conductive filler 75 may be dispersed in the polymeric matrix 80 using any mixing technique known to disperse solid particles into a liquid polymer. Upon mixing, the thermally conductive filler 75 comprises between about 5 wt. % to about 30 wt. % of the overall weight of the composite material 70. Alternatively, the thermally conductive filler 75 comprises between about 5 wt. % to about 25 wt. %; alternatively, between about 10 wt. % to about 20 wt. % of the overall weight of the composite material 70.

According to another aspect of the present disclosure, a battery pack with thermal management is provided. Referring once again to FIGS. 1 to 6, the battery pack generally comprises at least one battery and a cooling plate configured as previously described and as further defined herein. This cooling plate may be used to provide for thermal management of at least one battery in an electric vehicle (EV) or hybrid electric vehicle (HEV).

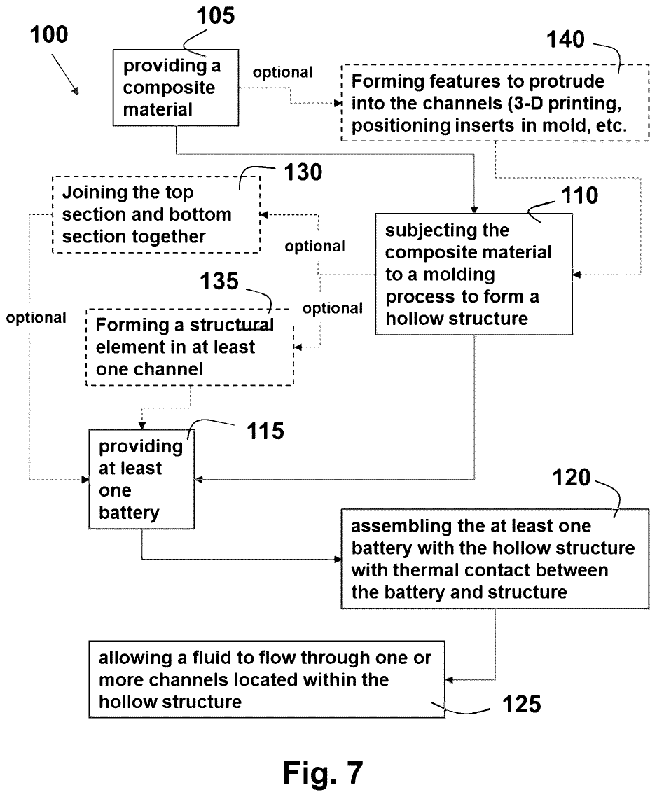

Referring now to FIG. 7, according to another aspect of the present disclosure, a process 100 for forming a battery pack as previously described and as further defined herein is provided. This process 100 generally comprises the steps of providing 105 a composite material; subjecting 110 the composite material to a molding process in order to form a hollow structure; providing 115 at least one battery; assembling 120 the at least one battery with the hollow structure, such that the battery is in thermal contact with the top section of the hollow structure; and allowing 125 a fluid to flow through the one or more channels located within the hollow structure. The molding process 110 is generally selected as one from the group of blow molding, injection molding, compression molding, rotational molding; or a combination thereof.

When desirable to form the top portion and the bottom portion of cooling plate separately, the process 100 may optionally include a joining step 130. This joining step 130 may comprise joining the top section and the bottom section 35 together to form a “leak-free” hollow structure through the use of one more of ultrasonic welding, spin welding, vibration welding, hot plate welding, infrared welding, laser welding, and overmolding techniques.

When a structural element configured to support the weight of the battery is incorporated into at least one of the channels in the cooling plate, the process may optionally comprise an additional forming 135 step for creating such structural element. This additional forming 135 step may include, but not be limited to a “Ship-in-the-Bottle” technology utilized in a blow molding process.

Finally, when the top section, the bottom section, or both the top and bottom section incorporate one or more features that protrude into one or more channels of the cooling plate in order to increase stiffness and/or promote fluid mixing by directing the flow of the fluid, the process may optionally comprise an additional forming 140 step for creating such feature(s). This additional forming step 140 is generally incorporated into the molding process 110 by including an additional step in creating the mold used in the molding process, such as through the use of 3-D printing or the positioning of inserts within the mold.

Those skilled-in-the-art, in light of the present disclosure, will appreciate that many changes can be made in the specific embodiments which are disclosed herein and still obtain alike or similar result without departing from or exceeding the spirit or scope of the disclosure. For example, although the cooling plate and process for producing the cooling plate as depicted in FIG. 1 through FIG. 7 show the top section of the cooling plate being in contact with the bottom of the batteries or battery modules in the battery pack, those skilled-in-the-art will understand that the cooling plate may be turned upside down, such that the top section of the cooling plate is in contact with the top surface of the batteries or battery modules without exceeding the scope of the scope of the present disclosure. In a similar fashion, when necessitated by or desired for a particular application the cooling plate may be configured such that the top section of the cooling plate is in thermal contact with one or more sides of the batteries or battery modules within the battery pack. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. Thus, the invention is not limited in its execution to the abovementioned preferred exemplary embodiments. Rather, a number of variants are conceivable that make use of the illustrated solution even in the form of fundamentally different embodiments. All such modifications and variations are within the scope of the invention as determined by the appended claims when interpreted in accordance with the breadth to which they are fairly, legally, and equitably entitled.

1. A cooling plate for battery thermal management, the cooling plate comprising a composite material formed in the shape of a hollow structure, the composite material having a composition that includes a thermally conductive filler dispersed within a polymeric matrix;
wherein the hollow structure has an external wall with a thickness that is in the range of about 0.3 millimeters (mm) to about 2.5 mm, the hollow structure comprising:
a top section, the top section being in thermal contact with at least one battery;
a bottom section; the bottom section being integrally formed with the top section; and
one or more channels located between the top section and the bottom section,
the one or more channels being configured to allow a fluid to flow there through in order to provide for thermal management of the battery.

2. The cooling plate according to claim 1, wherein the thermally conductive filler comprises a plurality of particles having a composition selected from the group consisting of boron nitride, alumina, aluminum nitride, silicon nitride, silicon carbide, graphene, carbon nanotubes, or a mixture thereof.

3. The cooling plate according to claim 1, wherein the polymeric matrix is an elastomer, a thermoplastic, or a thermoplastic elastomer (TPE) having a Shore A hardness that is in the range of about 40 to 100 or a Shore D hardness that is in the range of 20 to about 75.

4. The cooling plate according to claim 1, wherein the composition of the composite material comprises a plurality of boron nitride particles dispersed in a thermoplastic elastomer (TPE) having a Shore A hardness in the range of about 70 to about 80.

5. The cooling plate according to claim 1, wherein the thermally conductive filler has a low level of electrical conductivity.

6. The cooling plate according to claim 1, wherein the one or more channels includes a structural element configured to support the weight of the battery.

7. The cooling plate according to claim 1, wherein at least one of the bottom section and top section includes one or more features configured to increase stiffness and to promote fluid mixing by directing the flow of the fluid;
wherein at least one of the features protrudes into the one or more channels from the top section, the bottom section, or both the top section and bottom section.

8. The cooling plate according to claim 1, wherein the top section is flat in order to maintain at least 50% surface contact with the battery

9. The cooling plate according to claim 1, wherein the top section includes one or more bump stops configured to assist in battery placement and retention.

10. The cooling plate according to claim 1, wherein the wall thickness is in the range of about 1.0 mm to about 2.0 mm.

11. The cooling plate according to claim 6, wherein the structural element has a composition that is different from the composition of the cooling plate.

12. The cooling plate according to claim 1, wherein the hollow structure results in less than about 15% volume change upon allowing the fluid to flow through the one or more channels.

13. The cooling plate according to claim 1, wherein the hollow structure is formed as a single component.

14. The cooling plate according to claim 1, wherein the thermally conductive filler comprises between about 5 wt. % to about 25 wt. % of the overall weight of the composite material.

15. A battery pack with thermal management, wherein the battery pack comprises:
at least one battery; and
a cooling plate according to claim 1, wherein the cooling plate comprises a composite material formed in the shape of a hollow structure, the composite material having a composition that includes a thermally conductive filler dispersed within a polymeric matrix;
wherein the hollow structure has an external wall with a thickness that is in the range of about 0.3 millimeters (mm) to about 2.5 mm, the hollow structure comprising:
a top section, the top section being in thermal contact with the at least one battery;
a bottom section; the bottom section being integrally formed with the top section; and
one or more channels located between the top section and the bottom section, the one or more channels being configured to allow a fluid to flow there through in order to provide for thermal management of the battery pack.

16. The battery pack according to claim 15, wherein the thermally conductive filler comprises a plurality of particles having a composition selected from the group consisting of boron nitride, alumina, silicon nitride, graphene, carbon nanotubes, or a mixture thereof;
wherein the polymeric matrix is an elastomer, a thermoplastic, or a thermoplastic elastomer (TPE) having a Shore A hardness that is in the range of about 40 to 100 or a Shore D hardness that is in the range of 20 to about 75;
wherein the thermally conductive filler comprises between about 5 wt. % to about 25 wt. % of the overall weight of the composite material.

17. The use of the cooling plate according to claim 1 to provide for thermal management of at least one battery in an electric vehicle (EV) or hybrid electric vehicle (HEV).

18. A process of forming a battery pack configured for thermal management according to claim 13, wherein the process comprises:
providing a composite material;
subjecting the composite material to a molding process in order to form a hollow structure having a top section, a bottom section, and one or more channels;
forming one or more structural elements in the hollow structure, the structural elements configured to support the weight of the battery within at least one channel and having a composition that is different from the composition of the cooling plate, and/or the structural elements defining features that protrude into the one or more channels from the top section, a bottom section, or both the top and bottom sections, the features being configured to increase stiffness and to promote fluid mixing by directing the flow of the fluid;
providing at least one battery;
assembling the at least one battery with the hollow structure, such that the battery is in thermal contact with a top section of the hollow structure; and
allowing a fluid to flow through one or more channels located within the hollow structure.

19. The process according to claim 18, where in the molding process is selected as one from the group consisting of blow molding, injection molding, compression molding, rotational molding; or a combination thereof

20. The process according to claim 18, wherein the process further comprises:
forming one or more structural elements configured to support the weight of the battery within at least one channel, the one or more structural elements having a composition that is different from the composition of the cooling plate; and/or
forming one or more features that protrude into the one or more channels from the top section, a bottom section, or both the top and bottom sections, the features being configured to increase stiffness and to promote fluid mixing by directing the flow of the fluid.
